(19) United States
(12) Patent Application Publication
(10) Pub. No.: US 2002/0195736 A1
(43) Pub. Date: Dec. 26, 2002

(54) Steam chest for use with vertical and horizontal presses and method of use thereof

(76) Inventor: William R. Potter, Waterloo (CA)

Correspondence Address: DARYL W SCHNURR, BARRISTER & SOLICITOR, PO BOX 2607, 18 WEBER STREEST WEST, KITCHENER, ONTARIO, N2H 6N2, CA

(21) Appl. No.: 09/883,930

(22) Filed: Jun. 20, 2001

(51) Int. Cl. B29C 44/02

(52) U.S. Cl. 264/51; 425/4 R; 425/86; 425/407

(57) ABSTRACT

A steam chest can be used with both a vertical press and a horizontal press to manufacture foam prototypes in molding plates. The steam chest has a frame that can accept tooling that has been manufactured on a horizontal press or a vertical press. The same steam chest can be used to produce foam prototypes of various shapes and sizes within a particular size range. When the steam chest is used in a vertical press, the drainage hole that extends downward is in an edge wall. When the steam chest is used in a horizontal press, the drainage hole that extends downward is in a side wall.

### BACKGROUND OF THE INVENTION

1. Field of Invention

This invention relates to a steam chest and a method of use thereof. More particularly, this invention relates to a steam chest into which tooling manufactured on a horizontal press can be placed on a vertical press.

2. Description of the Prior Art

Previously, when manufacturing prototype foams of various sizes or shapes corresponding to particular parts, if the part to be reproduced in a prototype foam was manufactured on a particular type of press, the prototype foam had to be manufactured on the same type of press. For example, when a tool was manufactured on a Styrologic vertical press, the prototype foam also had to be manufactured on a Styrologic vertical press. Similarly, if a tool had been manufactured on a Kurtz horizontal press, the prototype foam also had to be manufactured on a Kurtz horizontal press. Also, where tools varied greatly in size, different size presses would be required to produce the prototype foams. Further, when manufacturing prototype foams, each size of foam requires a different steam chest, greatly increasing the time required and greatly increasing the expense.

### SUMMARY OF THE INVENTION

It is an object of the present invention to provide a device and method whereby prototype foams can be manufactured on a horizontal press where the original tooling was manufactured on a vertical press or vice versa. It is a further object of the present invention to accommodate molds of various shapes and sizes in the same steam chest. It is still a further object of the present invention to greatly reduce the time input required to produce prototype foams.

A steam chest is used with both a vertical press and a horizontal press. The steam chest comprises two shells, each shell having an opening along one side with a flange surrounding the opening. There are two flanges, one for each shell. A cavity frame has a periphery that is sized and shaped to correspond to the flanges, the frame being sandwiched between the flanges when the chest is assembled. The shells define a cavity therein and each shell has one side wall and at least one edge wall extending normal to the side wall. There are two side walls and at least two edge walls. At least one side wall and one edge wall have drainage holes therein. The drainage holes have removable plugs so that the drainage holes in the side wall can be plugged and the drainage holes in the edge wall can be unplugged when the chest is used within a horizontal press and vice versa when the chest is used in a vertical press.

A method of using tooling, manufactured on a vertical press, or a horizontal press or vice versa uses a steam chest having two shells. Each shell has one side wall with at least one edge wall extending from a periphery thereof. Each shell has an opening along one side thereof with a flange surrounding the opening. There are two flanges, one for each shell. At least one shell has an edge wall with a drainage hole therein and one side wall with a drainage hole therein. The shells are sized and shaped to receive a frame in which tooling from the horizontal press can be mounted. The method comprises mounting the tooling in the frame, mounting the frame between the flanges of the shells so that the frame can be sandwiched between the flanges, rigidly and removably securing the flanges against either side of the frame by mounting the steam chest in a horizontal press with the side wall containing the drainage hole extending downward or mounting the steam chest in a vertical press with the edge wall containing the drainage hole extending downward..

A method of using a steam chest in both a vertical press and a horizontal press uses a steam chest having two shells. Each shell has an opening along one side thereof with a flange surrounding the opening. There are two flanges, one for each shell. A frame has a periphery that is sized and shaped to correspond to the flanges. The frame is sandwiched between the flanges when the chest is assembled with the shells defining a cavity therein. Each shell has one side wall and at least one edge wall extending normal to the side wall. There are two side walls and at least two edge walls. At least one side wall and one edge wall have drainage holes therein with removable plugs. The method comprises mounting the tooling in an appropriately sized frame for that tooling, mounting the frame between the flanges of the two shells, mounting the steam chest in a vertical press with the edge wall containing the drainage hole extending downward or mounting the steam chest in a horizontal press with the side wall containing the drainage hole extending downward.

A method of manufacturing foam prototypes of various shapes and sizes using the same steam chest uses a steam chest having two shells that together enclose a cavity. The chest is able to accept tooling of various shapes and sizes within a specified range. The method comprises choosing a frame having a section or sections that are sized to receive the tooling and mounting the tooling in a section of the frame. The frame is sized to fit within the steam chest. The method further comprises installing the frame against a flange of one shell of the steam chest, mounting the steam chest in a horizontal or vertical press so that the operation of the press opens and closes the steam chest with the frame in between the two shells, filling the tooling with foam beads, heating the tooling by introducing steam into the steam chest to expand and fuse the beads, subsequently cooling the steam chest, retrieving the foam prototype formed in the tooling and repeating the method for tooling of a different size and shape by choosing a different frame while using the same steam chest.

### BRIEF DESCRIPTION OF THE DRAWINGS

In the drawings:

FIG. 1 is an exploded perspective view of one half of a steam chest;

FIG. 2 is an exploded perspective view of another half of the steam chest of FIG. 1.

FIG. 3 is a top view of a single section frame;

FIG. 4 is a top view of a dual section frame;

FIG. 5 is a top view of a further embodiment of a dual section frame; and

FIG. 6 is a top view of a three section frame;

### DESCRIPTION OF A PREFERRED EMBODIMENT

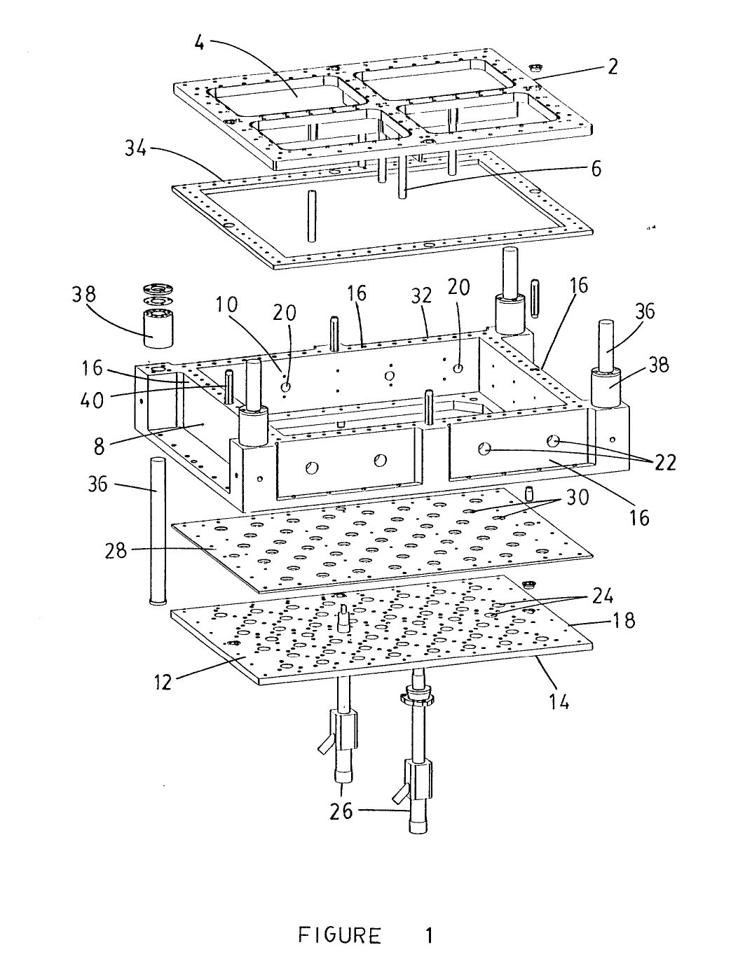

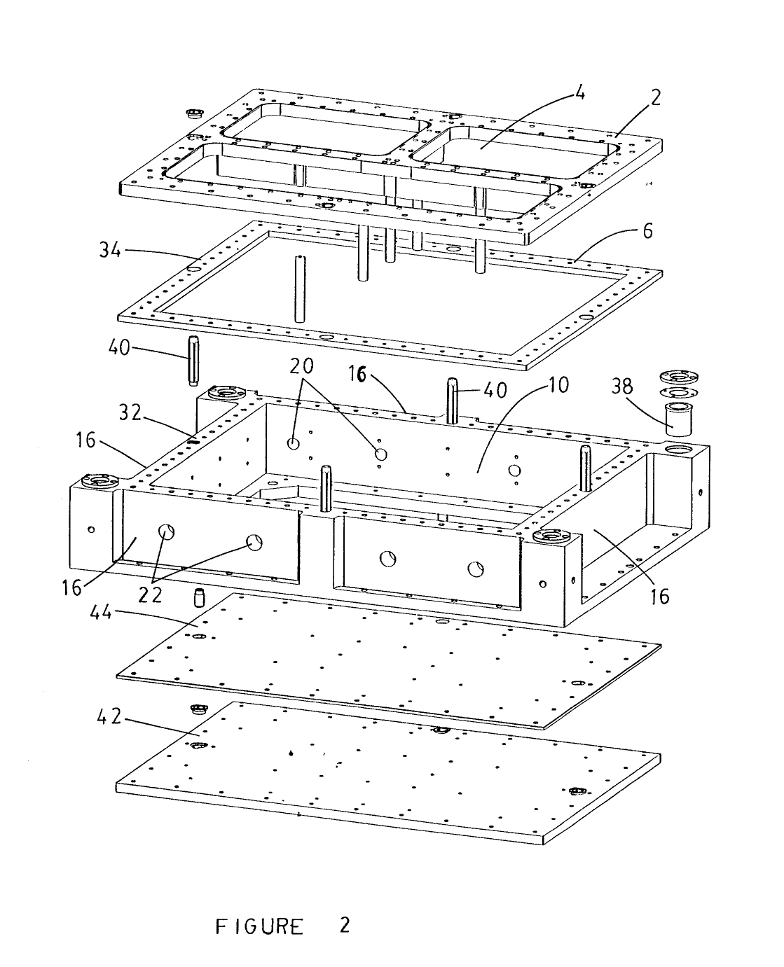

In FIGS. 1 and 2, a frame 2 has four sections 4. The frame 2 is shown in both FIG. 1 and in FIG. 2 and provides a point of reference for each of the Figures. There is only one frame in the steam chest at one time. The steam chest will preferably have several frames for tooling of different shapes and sizes. Each section 4 is sized to receive one piece of tooling (not shown). Supports 6 are affixed to the frame to provide support for the frame. A shell 8 has an opening 10 along one side thereof. The shell 8 has a cover 12 that forms a side wall 14. Four edge walls 16 extend normal to a periphery 18 of the cover 12. Two of the edge walls 16 contain two steam/water inlet openings 20 and two steam outlet/drainage holes 22. The cover 12 contains a plurality of openings 24 to receive fill guns 26. A plastic liner 28 is located between the cover 12 and the shell 8 and the liner 28 has a plurality of openings 30 which are aligned with the openings 24 of the cover 12. The openings 24 are covered except for those openings that receive a fill gun and except for at least one is left open to provide drainage if the steam chest is used in a horizontal press. A flange 32 surrounds the opening 10 of the shell 8. A gasket 34 corresponds in size and shape to the flange 32 and lies between the frame 2 and the flange 32. An interior of the edge walls 16 also contain a layer of plastic (not shown). The liner 28, gasket 34 and the plastic along the inside of the edge walls 16 insulate the steam chest. Posts 36 and retainers 38 provide means for aligning the shell 8 shown in FIG. 1 to a shell 8 shown in FIG. 2 so that the frame 2 is sandwiched between the flanges 32 of the shells 8. The same reference numerals are used in FIG. 2 to describe those components that are identical to the components of FIG. 1. Guide posts 40 assist in aligning the two shells 8. A cover 42 and corresponding liner 44 shown in FIG. 2 do not have openings for the foam guns as the foam can be inserted through the openings 24 in the cover 12. The cover 42 could be designed to include openings for the foam guns. The foam guns are designed to be inserted into the openings 24 so that foam beads can pass directly from the barrel of the guns into the mold plate.

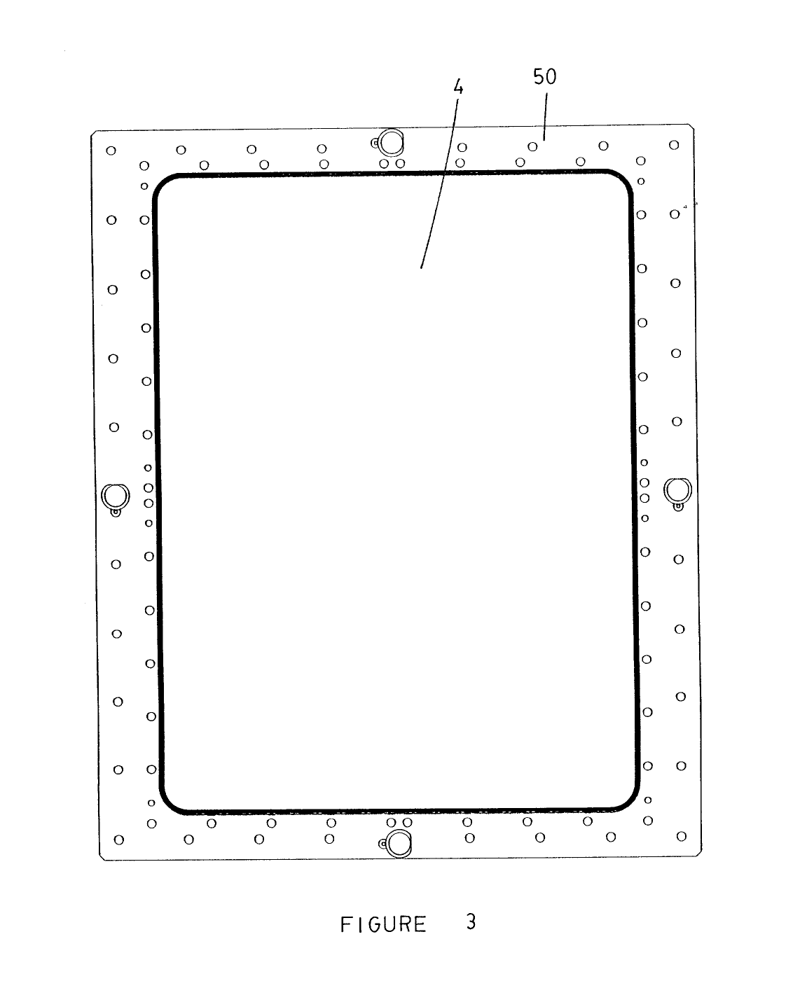

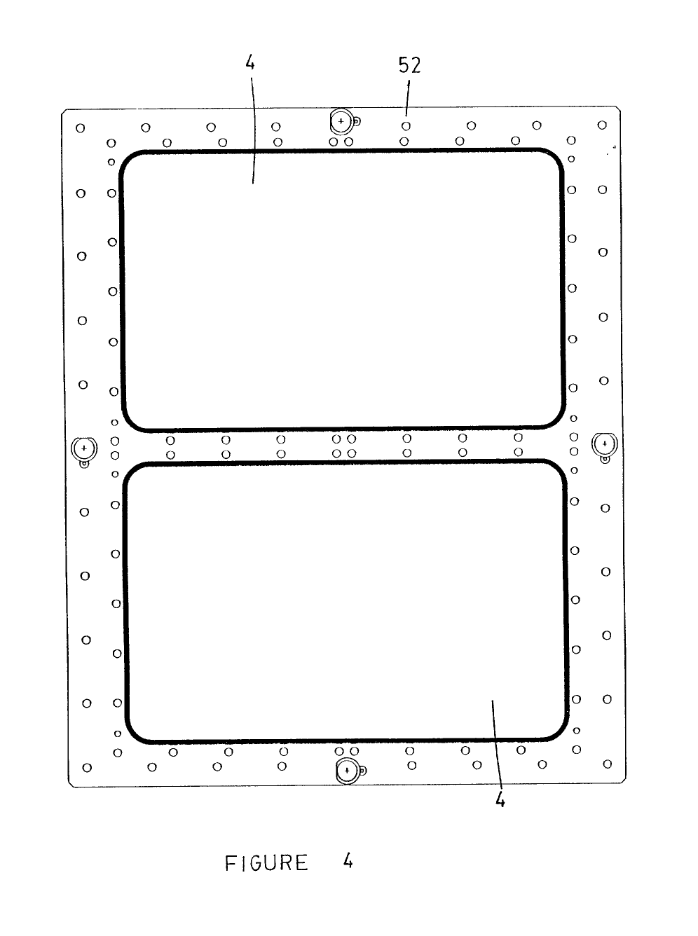

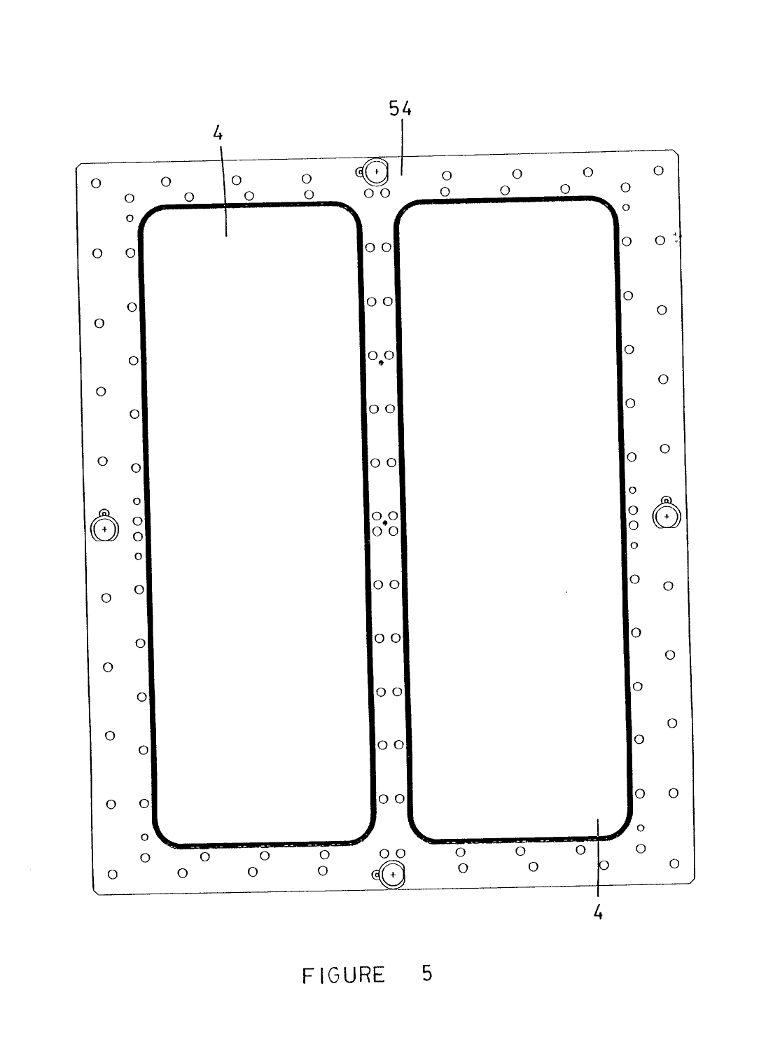

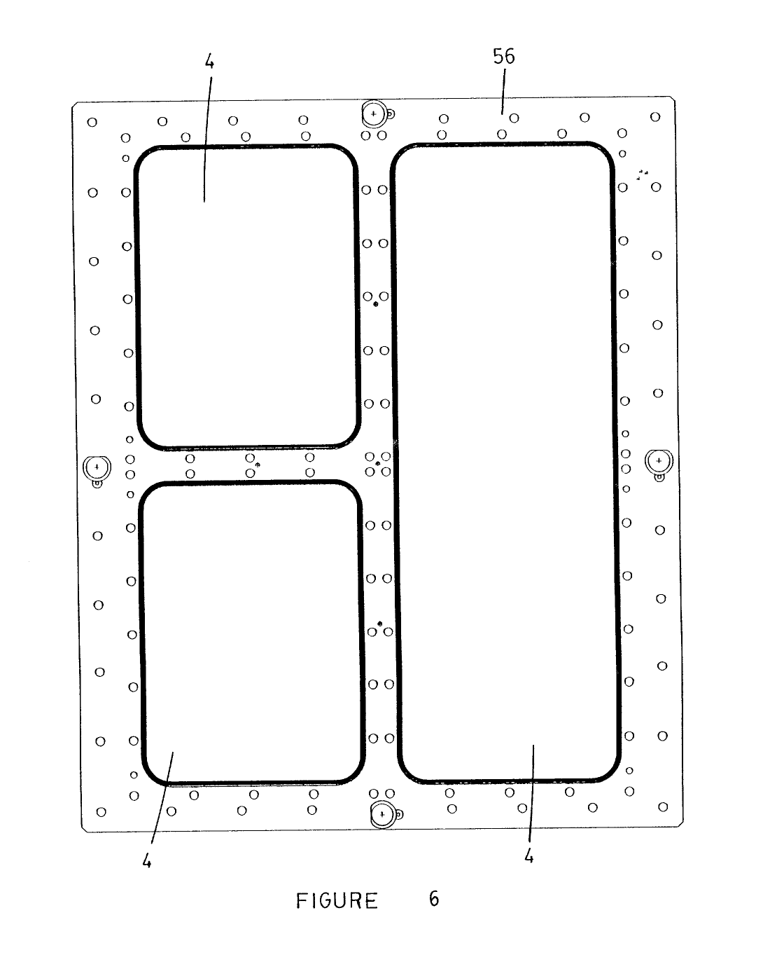

In FIG. 3, there is shown a top view of a frame 50 having a single section 4. In FIG. 4, there is shown a top view of a frame 52 having two sections 4. In FIG. 5, there is shown a top view of a frame 54 with two sections 4 of a different size than the sections 4 of FIG. 4. In FIG. 6 there is shown a top view of a frame 56 having three sections 4. In operation, each section contains a mold plate (not shown).

In operation, a mold plate (not shown), containing the mold of the component for which a foam prototype is desired to be produced, is installed within a frame. The steam chest of the present invention is designed to receive Styrologic frames, Kurtz frames or frames of other press manufacturers. The frame and mold plate is then mounted in one of the shells and the shell is mounted in a press. The other shell is also mounted in the press and is then aligned with the frame. The press can then be operated to open or close the steam chest. Assuming that the press is a Kurtz horizontal press, the steam chest will be placed in the press with the cover 12 facing downward. The fill guns would be connected so that foam beads can be injected into the mold plate or mold plates within the frame. The foam beads are preferably made from a suitable polymer. The polymer that is suitable for some tooling is expandable polystyrene. The steam and water connections are also made and the drainage hole on the cover 12 would be unplugged. The press is used to open or close the steam chest together with the frame sandwiched in between.

As is conventional, after all of the connections have been made, the foam beads are injected by the fill guns into the mold plate (or plates) within the frame. After the mold plate has been filled with foam beads, steam is introduced into the steam chest. The steam causes the foam beads to expand and to fuse together to fill the interior of the mold plate with a homogeneous foam material. The steam supply is then shut off and, after insuring that the foam has had time to fuse properly cooling water is introduced into the steam chest to cool the mold plate. The cooling water flows out of the drainage hole or holes in the cover. After cooling, the hydraulic pressure of the press is released and the steam chest can be opened. The mold plate is removed and opened and the foam prototype is removed.

From FIGS. 3 to 6, can be seen that a large mold plate can be used with the frame 50 whereas a small mold plate must be used with the frame 2 shown in FIG. 1 as the frame 2 has four sections, but has the same peripheral size as the frame 50. Thus, a reasonably broad range of sizes of mold plates can be used by choosing the appropriate size frame from FIGS. 1 to 6. The frames can all be used in the same size steam chest. When mold plates exceed the maximum size that can fit within frame 2, a different size of steam chest will have to be used. Each size of steam chest will have its own range of single section and multi-section frames which will accommodate many different sizes of mold plates. Also, in some uses of the invention, it may be desirable to leave one or more of the sections of the frame blank when manufacturing a foam prototype. It is not essential that all of the sections contain a mold plate during operation of the steam chest. Alternatively, blank plates can be used to fill in those sections of the frame for which there is no mold plate.

If desired, adapters can be used to increase the depth of the steam chest to accept unusually large parts or tooling. Since the frames are interchangeable within a steam chest of a particular size and only the mold plates vary, a significant time saving is achieved in manufacturing foam prototypes as the steam chest and frames already exist. As soon as the mold plate is available, the foam prototype can be manufactured. The same steam chest is used with many different sizes and shapes of mold plates.

I claim:

1. A steam chest for use with both a vertical press and a horizontal press, said steam chest comprising two shells, each shell having an opening along one side thereof with a flange surrounding said opening, there being two flanges, one for each shell, a cavity frame having a periphery that is sized and shaped to correspond to said flanges, said frame being sandwiched between said flanges when said chest is assembled, said shells defining a cavity therein, each shell having one side wall and at least one edge wall extending normal to said side wall, there being two side walls and at least two edge walls, at least one side wall and one edge wall having drainage holes therein, said drainage holes having removable plugs so that the drainage holes in the side wall can be plugged and the drainage holes in the edge wall can be unplugged when the chest is used within a horizontal press and vice versa when the chest is used in a vertical press.

2. A steam chest as claimed in claim 1 wherein the two shells are identical to one another.

3. A steam chest as claimed in claim 1 wherein the steam chest has fill gun openings that permit a fill gun to contact a mold plate, a steam inlet and outlet and a cooling water inlet and outlet, said chest being insulated.

4. A steam chest as claimed in claim 1 wherein the frame has a section therein for receiving a mold plate.

5. A steam chest as claimed in claim 4 wherein the frame has multiple sections therein for receiving multiple mold plates, there being one mold plate for each section.

6. A method of using tooling manufactured on a vertical press on a horizontal press or vice versa causing a steam chest having two shells, each shell having one side wall with at least one edge wall extending from a periphery thereof, each shell having an opening along one side thereof with a flange surrounding said opening, there being two flanges, one for each shell, at least one shell having an edge wall with a drainage hole therein and a side wall with a drainage hole therein, said shells being sized and shaped to receive a frame in which said tooling from said vertical press can be mounted, said method comprising mounting said tooling in said frame plate, mounting said frame on said flange of one of said shells, mounting each shell of said steam chest in a horizontal press with the side wall containing said drainage hole extending downward or in a vertical press with the edge wall containing said drainage hole extending downward, operating said press to close said steam chest with said frame sandwiched between said flanges.

7. A method as claimed in claim 6 including the steps of installing a mold plate into the frame, filling the mold plate with expandable foam beads using a fill gun or fill guns, circulating steam through the steam chest to cause the foam beads to expand and gel together, subsequently circulating cooling water through the steam chest, removing the steam chest from the press and removing the mold plate from the steam chest.

8. A method of using a steam chest in both a vertical press and a horizontal press using a steam chest having two shells, each shell having an opening along one side thereof with a flange surrounding said opening, there being two flanges, one for each shell, a frame having a periphery that is sized and shaped to correspond to said flanges, said frame being sandwiched between said flanges when the chest is assembled with the shells defining a cavity therein, each shell having one side wall and at least one edge wall extending normal to said side wall, there being two side walls and at least two edge walls, at least one side wall and one edge wall having drainage holes therein with removable plugs, said method comprising mounting tooling within said frame, mounting said frame between the flanges of said two shells, mounting the steam chest in a vertical press with an edge wall containing the drainage hole extending downward or mounting said steam chest in a horizontal press with the side wall containing the drainage hole extending downward, operating the press to open or close the steam chest.

9. A method as claimed in claim 8 including the steps of mounting a mold plate within said frame, filling the mold plate with foam beams using a fill gun or fill guns, circulating steam through the steam chest to expand the beads and cause them to gel, subsequently circulating cooling water through the steam chest.

10. A method as claimed in claim 9 including the steps of inserting a frame with two sections into one shell of the steam chest, each section containing a mold plate, and filling each mold plate with foam beads using fill guns.

11. A method of manufacturing foam prototypes of various shapes and sizes using the same steam chest said steam chest having two shells that together enclose a cavity, said chest being able to accept tooling of various shapes and sizes within a specified range, said method comprising choosing a frame having a section or sections mounting the tooling in a section of said frame, said frame being sized to fit within the steam chest, installing the frame against a flange of one shell of the steam chest, mounting the steam chest in a horizontal or vertical press so that the operation of the press opens and closes the steam chest with the frame in between said two shells, filling the tooling with foam beads, heating the tooling by introducing steam into the steam chest to expand and fuse the beads, subsequently cooling the steam chest, retrieving the foam prototype formed in the tooling, repeating the method for tooling of a different size and shape by choosing a different frame while using the steam chest.
